(19) United States
(12) Patent Application Publication
(10) Pub. No.: US 2022/0403535 A1
(43) Pub. Date: Dec. 22, 2022

(54) CATALYST

(71) Applicants: NewSouth Innovations Pty Limited, Sydney (AU); Kohodo Hydrogen Energy Pty Ltd, Sydney (AU)

(72) Inventors: Chuan Zhao, Sydney (AU); Yibing Li, Sydney (AU); Xin Bo, Sydney (AU)

(21) Appl. No.: 17/859,325

(22) Filed: Jul. 7, 2022

Related U.S. Application Data
(63) Continuation of application No. PCT/AU2021/050014, filed on Jan. 8, 2021.

(30) Foreign Application Priority Data
Jan. 10, 2020 (AU) 2020900067

(51) Int. Cl. C25B 11/075; C25B 1/04; C25B 11/031; C25B 11/061

(52) U.S. Cl. CPC C25B 11/075; C25B 1/04; C25B 11/031; C25B 11/061

(57) ABSTRACT

A catalyst comprising a porous electrically conductive substrate (such as a foam, carbon fibre paper and carbon fibre cloth) and a porous metallic composite of amorphous NiMoP coating at least a portion of the surface or multiple surfaces of the substrate. The composite preferably forms a continuous layer which coats the surfaces and pores of the substrate. Also methods for preparing and using the catalyst, for example in electrolytic water splitting.

### FIELD

The present invention relates to catalysts, especially catalysts for the hydrogen evolution reaction, and methods for their preparation. The present invention also relates to electrodes comprising the catalysts. The present invention further relates to methods of using the catalysts and electrodes.

### BACKGROUND

There is currently considerable interest in the development of sustainable energy sources. Hydrogen (H₂) is being explored as a renewable fuel and as an alternative to fossil fuels in transport applications. An abundant, accessible and sustainable source of hydrogen is from the electrolytic splitting of water to generate hydrogen and oxygen. However, to make this process efficient and a viable alternative to fossil fuels, highly efficient water-splitting catalysts are required to lower the energy input required for the process to occur.

Platinum-group metal catalysts are currently being used as efficient water-splitting catalysts, in particular as catalysts for the hydrogen evolution reaction (HER). However, the materials used in platinum-group metal catalysts are scarce and prohibitively expensive, limiting the broader application of these catalysts.

Accordingly, there is a need for effective water-splitting catalysts, including catalysts that can be prepared using relatively inexpensive materials.

### SUMMARY

The present invention is predicated at least in part on the discovery that an amorphous NiMoP composite can be used as a water-splitting catalyst, in particular as a catalyst for the hydrogen evolution reaction.

In one aspect of the present invention, there is provided a catalyst comprising:
a porous electrically conductive substrate, and
a porous metallic composite coating at least a portion of the surface of the substrate,
wherein the porous metallic composite is amorphous NiMoP.

In another aspect of the present invention, there is provided a method for preparing the catalyst described herein, the method comprising the steps of:
providing a porous electrically conductive substrate, and
coating at least a portion of the surface of the porous electrically conductive substrate with a porous metallic composite,

wherein the porous metallic composite is amorphous NiMoP.

In another aspect of the present invention, there is provided the use of the catalyst described herein or prepare according to the methods described herein as a catalyst for the hydrogen evolution reaction.

In another aspect of the present invention, there is provided an electrode comprising the catalyst described herein or prepared according to the method described herein.

In another aspect of the present invention, there is provided the use of the electrode described herein for electrolytic water splitting.

In another aspect of the present invention, there is provided a method for electrolytic water splitting, the method comprising:
passing an electrical current through an aqueous solution using an electrolyser comprising an anode and a cathode;

wherein the cathode comprises the catalyst described herein or prepared according to the method described herein.

### BRIEF DESCRIPTION OF THE DRAWINGS

FIG. 1. Panels a) and b) are scanning electron microscopy (SEM) images of an NiMoP composite on nickel foam (NF) substrate. Panels c) and d) are transmission electron microscopy (TEM) and high-resolution TEM (HRTEM) images respectively of the NiMoP composite sonicated from the NF substrate. Panels e) and f) are TEM-BF and selected TEM-EDS mapping images respectively of the NiMoP composite.

FIG. 2 illustrates XRD patterns of Ni, NiMo, NiP and NiMoP composites on carbon fibre paper (CFP) substrates.

FIG. 3 illustrate X-ray photoelectron spectroscopy (XPS) data of Ni2p (panel a), O1s (panel b), Mo3d (panel c) and P2p (panel d) of Ni, NiMo, NiP and NiMoP composites on CFP substrates.

FIG. 4 illustrate the electrochemical performance of NiMoP composites prepared using different amounts of Ni (panel a), Mo (panel b) and P (panel c) and different depositing times (panel d).

FIG. 5 depict the electrochemical performance of the NiMoP composite on copper foam (CF) substrate in 1M potassium hydroxide aqueous solution. Panel (a) illustrates the linear sweep voltammetry (LSV) for HER performance for NiMo, NiP and NiMoP composites on CF substrate and for Pt mesh, and panel (b) illustrates the derived Tafel Slopes. Panel (c) illustrates the LSV for HER performance for the NiMoP composite on CF substrate compared to NF substrate. Panel (d) illustrates the chronopotentiometry of the NiMoP composite at an applied current density of 10 mA·cm⁻¹ for 10 hours. Panel (e) illustrates EIS plots of the NiMo, NiP and NiMoP composites under an applied potential of −0.10 V vs RHE (circles: measured, curves: simulated). Panel (f) illustrates the LSV performance of the NiMoP composite in a two-electrode water splitting system (anode: NiFeCr/NF, cathode: NiMoP/NF).

FIG. 6. Panel (a) illustrates the performance of the NiMoP composite in a flow cell simulator (anode: NiFeCr/NF, cathode: NiMoP/NF). Panel (b) illustrates Faraday Efficiency (FE) calculations from H₂ collection under 20 mA·cm⁻¹ and 50 mA·cm⁻¹ current density input respectively; panels (c)-(f) depict the electrochemical performance of the NiMoP composite on CF substrate in phosphate buffer saline aqueous solution. Panel (c) illustrates the LSV for HER performance for NiMo, NiP and NiMoP composites on CF substrate and for Pt mesh, and panel (d) illustrates the derived Tafel Slopes. Panel (e) illustrates the chronopotentiometry of the NiMoP composite at an applied current density of 10 mA·cm⁻¹ for 10 hours. Panel (f) illustrates EIS plots of the NiMo, NiP and NiMoP composites under an applied potential of −0.10 V vs RHE (circles: measured, curves: simulated).

### DETAILED DESCRIPTION

### 1. Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, “an element” means one element or more than one element.

As used herein, the term “about” refers to a quantity, value, dimension, size, or amount that varies by as much as 30%, 25%, 20%, 15% or 10% to a reference quantity, value, dimension, size, or amount.

As used herein, unless the context requires otherwise, the term “comprise”, and variations such as “comprises” and “comprising”, will be understood to imply the inclusion of a stated integer or step or group of integers or steps but not the exclusion of any other integer or step or group of integers or steps.

As used herein, the term “metallic composite” refers to a composite comprising a metal and at least one other element, where the at least one other element may or may not be a metal.

### 2. Catalyst

The present invention provides a catalyst comprising a porous electrically conductive substrate, and a porous metallic composite coating at least a portion of the surface of the substrate.

The porous metallic composite is amorphous NiMoP. The porous metallic composite coats at least a portion of the surface of the substrate. It may not be necessary to entirely coat the surface of the substrate. However, it may be appreciated that coating the substrate in its entirety may provide optimum performance. In some embodiments, the porous metallic composite coats multiple surfaces of the substrate, for example substrate surfaces throughout the substrate including surfaces of the pores in the substrate. In some embodiments, the porous metallic composite is a continuous layer which coats the surfaces and pores of the substrate.

The thickness of the porous metallic composite may be varied by varying the time taken to deposit the composite and/or the current density used during electrodeposition. In some embodiments the thickness of the porous metallic composite may be between about 0.01 μm to about 100 μm for a deposit time of 1 to 120 minutes.

The amorphous NiMoP has a non-crystalline structure as evidenced by abundant defects and a broad peak at 44° 2theta and the reduction or disappearance of Ni lattice peaks at 55° and 76° 2theta in X-ray diffraction (XRD). The absence of lattice fringes and rings in transmission electron microscopy (TEM) and selected area electron diffraction (SAED) is also indicative of an amorphous structure.

The porous electrically conductive substrate may be any suitable substrate for use in a catalyst, especially a catalyst for use in water electrolysis for hydrogen production. Suitable substrates are not only conductive but may have properties such as one or more of mechanical strength, porosity and large surface area. Examples of suitable substrates include foams, carbon fibre paper and carbon fibre cloth. In some embodiments, the porous electrically conductive substrate is a foam. Suitable foams include copper foam, nickel foam, graphite foam, nickel-iron foam, titanium foam and stainless steel foam. In some embodiments, the foam is copper foam or nickel foam.

As described further below and as shown in the Examples, the porous metallic composite may be coated onto the porous electrically conductive substrate by electrodeposition. Accordingly, in some embodiments, the porous metallic composite is deposited onto the substrate surfaces by electrodeposition.

As described further below and as shown in the Examples, the porous metallic composite may exhibit catalytic activity, such as catalytic activity towards the hydrogen evolution reaction (HER). Accordingly, in some embodiments, the porous metallic composite exhibits catalytic activity, especially catalytic activity towards the hydrogen evolution reaction (HER).

The present invention also provides the use of the catalyst described herein as a catalyst for the hydrogen evolution reaction.

### 3. Methods of Preparation

The present invention provides methods for preparing the catalyst described herein. The method comprises the steps of providing the porous electrically conductive substrate described herein, and coating at least a portion of the surface of the substrate with the porous metallic composite described herein.

In some embodiments a portion of the surface of the substrate is coated. In other embodiments, multiple surfaces of the substrate are coated. In some embodiments, the composite forms a continuous coating on the surface and pores of the substrate.

The coating step may be carried out by electrodeposition of the porous metallic composite on to the surfaces of the porous electrically conductive substrate. As shown in the Examples, the catalyst of the present invention may advantageously be prepared using a facile one-step electrodeposition method. In some embodiments, the electrodeposition is performed in a two-electrode system. In some embodiments, electrodeposition is performed using an electrolyte bath comprising electrolytes of Ni²⁺, Mo⁶⁺ and PO₂³⁻. In some embodiments, the electrolyte bath comprises about 1 to about 20 mmol NiSO₄.6H₂O, especially about 5 to about 20 mmol, more especially about 10 mmol; about 1 to about 10 mmol Na₂MoO₄.2H₂O, especially about 3 mmol; and about 1 to about 100 mmol NaH₂PO₂.H₂O, especially about 40 to about 100 mmol, more especially about 40 mmol.

The electrodeposition process may a constant current electrodeposition process where electrodeposition is carried out under an applied DC current density, for example, under a current density of about 80 mA cm². The DC current may be applied for a period of time between 1 and 120 minutes, especially between 1 and 100 minutes, 1 and 80 minutes, 1 and 60 minutes, 1 and 40 minutes or 10 and 30 minutes, for example, for 20 minutes. Adjusting the current density and/or the deposition time may affect the properties of the porous metallic composite such as its thickness.

The method of the invention may further comprise the step of pre-treating the surface of the porous electrically conductive substrate to remove any oxide layer and/or contaminants prior to the coating step. In some embodiments, the pre-treating step comprises treating the substrate in an acidic solution, for example sonicating the substrate in dilute (e.g. about 4 M) hydrochloric acid solution.

The method of the invention may further comprise the step of rinsing the product of the coating step. In some embodiments, the rinsing step comprises rinsing the product of the coating step with water or ethanol.

### 4. Applications

The catalyst of the present invention may be useful in electrodes for water electrolysis for hydrogen production. Accordingly, the present invention provides an electrode comprising the catalyst described herein or prepared according to the method described herein. The present invention also provides the use of the electrode described herein for electrolytic water splitting.

In some embodiments, the catalyst of the electrode of the present invention exhibits catalytic activity towards the hydrogen evolution reaction. As shown in the Examples, the catalytic performance can occur under a near-theoretic potential and can have comparable or enhanced activity compared to a benchmark Pt mesh electrode. Without wishing to be bound by theory, the present inventors hypothesise that the Ni, Mo and P provide a synergistic effect which may enhance the M-H absorption and accelerate the charge transfer process for the hydrogen evolution reaction.

The present invention further provides a method for electrolytic water splitting, the method comprising passing an electrical current through an aqueous solution using an electrolyser comprising an anode and a cathode. The cathode comprises the catalyst described herein or prepared according to the methods described herein.

Advantageously, as shown in the Examples, the catalyst can exhibit catalytic activity under neutral and basic conditions (i.e. about pH 7 to about pH 14). In some embodiments, the aqueous solution has a pH within the range of about 7 to about 14, especially a pH of about 7.2 or a pH or about 14.

### EXAMPLES

### Example 1—Preparation of NiMoP Electrodes

All chemicals were purchased from supplier and directly used without further purification. Copper foam (CF), nickel foam (NF) or carbon fibre paper (CFP) were used as plating substrates. Before preparation, the substrates were sonicated in dilute hydrochloric acid solution (˜4 M) for 10 minutes to remove oxides on the surface, and then washed with Milli-Q water and dried. Aqueous plating baths (20 mL) were prepared containing 0-20 mmol nickel sulphate hexahydrate (NiSO₄.6H₂O Chem-Supply), 0-10 mmol sodium molybdate dihydrate (Na₂MoO₄.2H₂O Sigma), 0-100 mmol sodium hypophosphite hydrate (NaH₂PO₂.H₂O, Sigma), 3 mmol trisodium acetate dehydrate (Na₃C₆H₅O₇.2H₂O, Chem-Supply) and adjusted to pH 8.5 with ammonia solution (30%, NH₃.H₂O, Chem-Supply). Electrodeposition was carried out in a facile two-electrode system, where the counter electrode was nickel or graphite plate. The working substrates were cut into a certain size and sealed with Teflon tape to provide an exposed geometric surface area of 2.0×2.0 cm². Electrodeposition was driven by DC power (POWERTECH, MP3086) under 80 mA·cm⁻² current density for 1 to 120 min. After deposition, the electrodes were washed with water and dried in the fumehood. Control samples were fabricated via the same method described above using the relevant chemicals.

The optimized aqueous plating bath (electrolyte) for the NiMoP electrode contained 10 mmol NiSO₄.6H₂O, 3 mmol Na₂MoO₄.2H₂O, 40 mmol NaH₂PO₂.H₂O, 3 mmol Na₃C₆H₅O₇.2H₂O and 2 mL ammonia solution in 20 ml H₂O. The applied DC current density was 80 mA·cm⁻² for 20 min during constant current electrodeposition.

### Example 2—Physical Characterisation of the NiMoP Electrode

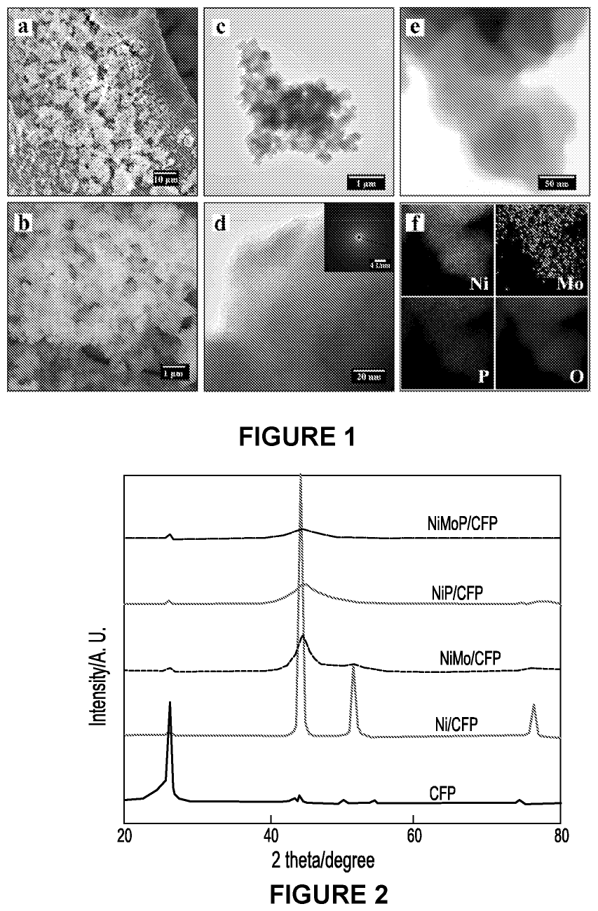

Transmission electron microscopy (TEM, JEOL, F200) and scanning electron microscopy (SEM, JSM7001F) attached with X-ray energy dispersive spectroscopy (EDS) were employed to observe the morphology and elemental contributions of the NiMoP electrode prepared in Example 1. Under the electrodeposition reaction, a black layer of NiMoP composite was coated on the NF substrate. FIG. 1, panels a and b are SEM images and show the morphology of the obtained NiMoP composite. The composite layer has a cluster structure on the frame substrate. For subsequent TEM analysis, the NiMoP electrode was subjected to ultrasonication in ethanol for 30 minutes and partial composites were peeled off from the NF substrate and collected onto a carbon grid. FIG. 1, panel c is a TEM image and FIG. 1, panel d is a high-resolution TEM (HRTEM) image of the NiMoP composite sonicated from the NF substrate. The NiMoP composite in FIG. 1, panel c shows aggregated microsphere morphology and the high-resolution photo (HRTEM) in FIG. 1, panel d depicts the amorphous structure without obvious lattice fringes and the halo patterns caught from selected area electron diffraction (SAED, insert in FIG. 1, panel d). The elemental distributions were determined using energy dispersive spectroscopy (EDS) on a certain area of the bright field TEM (TEM-BF) (FIG. 1, panel e). The TEM-EDS mapping is illustrated in FIG. 1, panel f and shows that Ni, Mo, P and O were uniformly dispersed on the composite.

To further determine the morphology, X-ray diffraction (XRD) was performed on a PANalytical X'Pert instrument with a very slow scanning rate of 1°·min⁻¹. A CFP substrate was used to avoid the strong diffraction peaks that would be obtained using copper or nickel substrates. FIG. 2 illustrates XRD patterns of Ni, NiMo, NiP and NiMoP composites on CFP substrates. The peaks at ˜26°, 43˜44°, 50°, 55° and 75° correlate well with the graphite facets of (002), (100), (101), (102), (004) and (110) orientation (Z. Q. Li et al., Carbon 2007, 45, 1686-1695). Apart from the multiple peaks attributed from the CFP substrate, the strong diffraction peaks at ˜44°, ˜51° and ˜76° are ascribed to the (111), (200) and (220) facets of metallic nickel, respectively (C. Jayaseelan et al., Ecotoxicol Environ Saf 2014, 107, 220-228). As Mo is introduced into the electrodeposited Ni layer, the orientation (110) peak of nickel is sharply decreased and broadened, indicating that an alloy Ni—Mo structure with abundant defects is obtained (the nickel metal lattice structure is maintained). When P is introduced, both NiP and NiMoP composites shows broadening of the 44° peak with the disappearance of the Ni (200) or (220), which indicates further lattice collapse to provide defective amorphous P-incorporated composites.

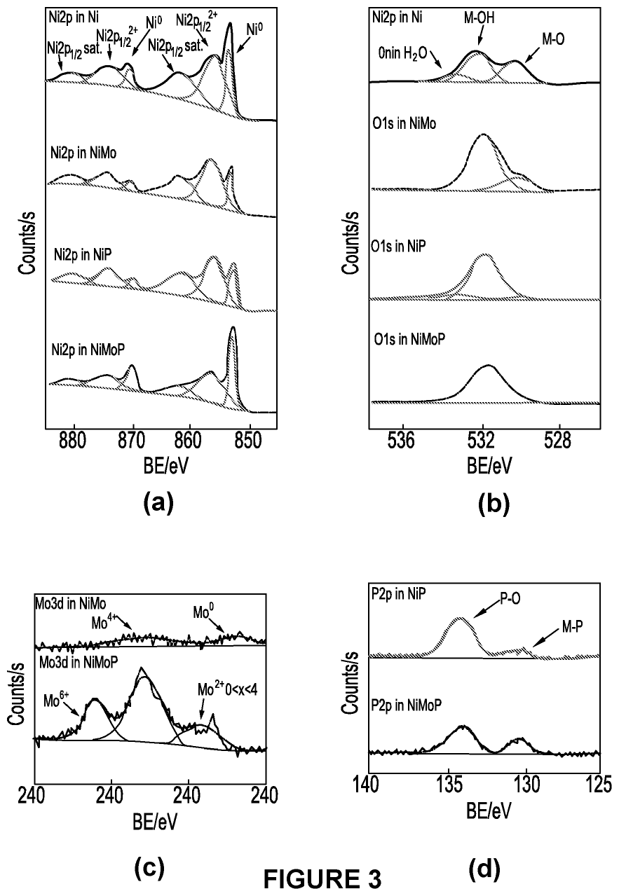

The electronic structures of NiMoP composites on CFP substrates were analysed by X-ray photoelectron spectroscopy (XPS, Thermo ESCALAB250i). Raman spectra were recorded on a Renishaw spectrometer by using a laser of λ=532 nm. FIG. 3 illustrate the XPS data of the NiMoP composites, with peak positions calibrated using C location. XPS was performed from the surface to the certain depth using Ar beam etching for 30 seconds to obtain the pristine composite from the surface oxidisation in the air spontaneously.

The Ni2p spectra in FIG. 3, panel a demonstrate the typical Ni⁰ and Ni²⁺ state in the bulky depth of Ni, NiMo, NiP and NiMoP composites (M. Schalenbach, et al., Electrochimica Acta 2018, 259, 1154-1161; N. Weidler et al., The Journal of Physical Chemistry C 2017, 121, 6455-6463; M. Gong et al., Nat Commun 2014, 5, 4695; M. Gong et al., Angew Chem Int Ed Engl 2015, 54, 11989-11993). The intensity of the metallic Ni⁰ in NiMoP and Ni on CFP are much stronger than that in NiMo and NiP composites, indicating the ternary NiMoP composite possesses more metallic Ni than that in other control compounds.

FIG. 3, panel b shows the cole level of O1s XPS data; the simulated peaks at ˜533.5 eV, ˜532.4 eV and 530.3 eV are attributed to the O in absorbed H₂O, M-OH and M-O bonds, respectively (X. Bo et al., ACS Appl Mater Interfaces 2017, 9, 41239-41245; X. Bo et al, Journal of Power Sources 2018, 402, 381-387; F. Caridi et al., Radiation Effects and Defects in Solids 2015, 170, 696-706; C. Zhang et al., Journal of Alloys and Compounds 2019, 781, 613-620). In comparison, the O-M content in Ni and NiMo are much higher than that in NiP and NiMoP, indicating incorporation of P can prevent surface oxidation of Ni. FIG. 3, panel c shows the core level XPS of Mo3d; a very weak Mo signal is obtained in the NiMo sample and Mo⁰ and Mo⁴⁺ states are observed, whereas the much stronger signal in the NiMoP composite shows newly-occurred Mo⁶⁺ and Mo^{x+} (0<x<4) in phosphate and phosphide compounds respectively (P. Xiao et al., Energy Environ. Sci. 2014, 7, 2624-2629; W. Cui et al., Applied Catalysis B: Environmental 2015, 164, 144-150; J. Kibsgaard and T. F. Jaramillo, Angew Chem Int Ed Engl 2014, 53, 14433-14437).

FIG. 3, panel d illustrates the P2p spectra, which indicates the co-existence of phosphate and phosphide compounds as the doublet peaks (P. Xiao et al., Energy Environ. Sci. 2014, 7, 2624-2629; W. Cui et al., Applied Catalysis B: Environmental 2015, 164, 144-150; J. Kibsgaard and T. F. Jaramillo, Angew Chem Int Ed Engl 2014, 53, 14433-14437; Y. Li and C. Zhao, ACS Catalysis 2017, 7, 2535-2541; L. Ai et al, Electrochimica Acta 2017, 242, 355-363).

### Example 3—Electrochemical Performance of the NiMoP Electrode

### Electrochemical Measurement

The NiMoP electrode prepared in Example 1 was assessed as working electrode (exposed geographic area 0.5×0.5 cm²) in a standard three-electrode system. A graphite rod and Ag/AgCl (in 1 M KCl) were used as counter and reference electrodes, respectively. The linear sweep voltammetry (LSV) was collected by CHI760D potentiostat at a scanning rate of 5 mV·s⁻¹ and repeated at least three times to reach the repeatable result in 1 M potassium hydroxide aqueous solution (KOH, Chem-Supply) and 1 M phosphate buffer aqueous solution (PBS, pH=7.2, containing K₂HPO₄ and KH₂PO₄, both from Chem-Supply). The recorded potential was converted to a Reversible Hydrogen Electrode (RHE) value by using the following equation:

E_{RHE}=E_{msd}+0.222+0.059 pH.

The chronopotentiometry under the applied current density of 10 mA·cm⁻¹ was collected to investigate the life duration of the electrode for hydrogen evolution. Furthermore, the electrochemical impedance spectroscopy (EIS) was measured in the same three-electrode cell as above using Autolab potentiostat (Metrohm). The scanning frequency of input sine signal ranged from 100 KHz to 0.05 Hz under a particular applied potential of −0.10 V vs RHE and the amplitude was 10 mV. The measured plots were analyzed by zimpwin software.

The Faraday Efficiency (FE) in industrial simulation was tested in a flow electrolyser system. The attached anode and cathode were NiFeCr/NF (3.0×3.0 cm²) and NiMoP/NF (3.0×3.0 cm²) respectively. The anodic and cathodic chambers were separated with an ion-exchange membrane (Suzhou Jingli, China) with 30 wt. % KOH aqueous solution fed with the flow pump rate of 40 mL·min⁻¹. The electrolyser was then utilized with Autolab using 10-Amp-Booster as a power supply to record the input current and feedback potential between the two working electrodes. Under an applied current density input, the production from cathodic chamber was afterwards experienced through the gas-liquid-separator and quantified the volume with the gas metre (Sigma) during a certain period. The FE can be calculated by the formula below:

Vₜₕᵣ=(V·j·s·t)/2F

FE=V_{msd}/Vₜₕᵣ=(2F·Vmsd)/(V·j·s·t)

where V is the standard gas volume of 22.4 L·mol⁻¹; Vₜₕᵣ and V_{mrd} are the produced H₂ theoretic and measured volumes, respectively, under the input current density (j) for a period (t); F is the Faraday constant of 96482 C/mol; and (s) is the working electrode area of 9.0 cm².

The above electrochemical processes including electrodeposition and performance were utilised with a nonprecious electrode as counter (to compare to the performance of Pt) and were without iR compensation.

The overall water splitting was also evaluated with the CHI760D potentiostat using the above-mentioned NiFeCr/NF as the counter anode. The linear sweep voltammetry (LSV) was collected at the scanning rate of 5 mV·s⁻¹ and repeated at least three times to reach the repeatable result in 1 M KOH aqueous solution.

The NiFeCr/NF was introduced as anode for counter OER in overall water splitting system. The anodic electrode was prepared via electrodeposition as described in X. Bo et al., ACS Appl Mater Interfaces 2017, 9, 41239-41245 and X. Bo et al., Journal of Power Sources 2018, 402, 381-387: a clean NF substrate with an exposed geometric surface area of 2.0×2.0 cm² were attached in a standard three-electrode system, where the counter and reference electrodes are graphite plate and Ag/AgCl (in 1 M KCl) respectively. The plating electrolyte contained 3.0 mM nickel nitrate (Ni(NO₃)₂·6H₂O, Ajax Finechem), 3.0 mM iron nitrate (Fe(NO₃)₃.9H₂O, Ajax Finechem), and 3.0 mM chromium nitrate (Cr(NO₃)₃.6H₂O, Ajax Finechem) and the applied potential was −1.0 vs reference for 5 min. The obtained electrode (denoted as NiFeCr/NF) was carefully removed from the electrolyte, rinsed with water, and dried in a fumehood.

### Electrochemical Performance

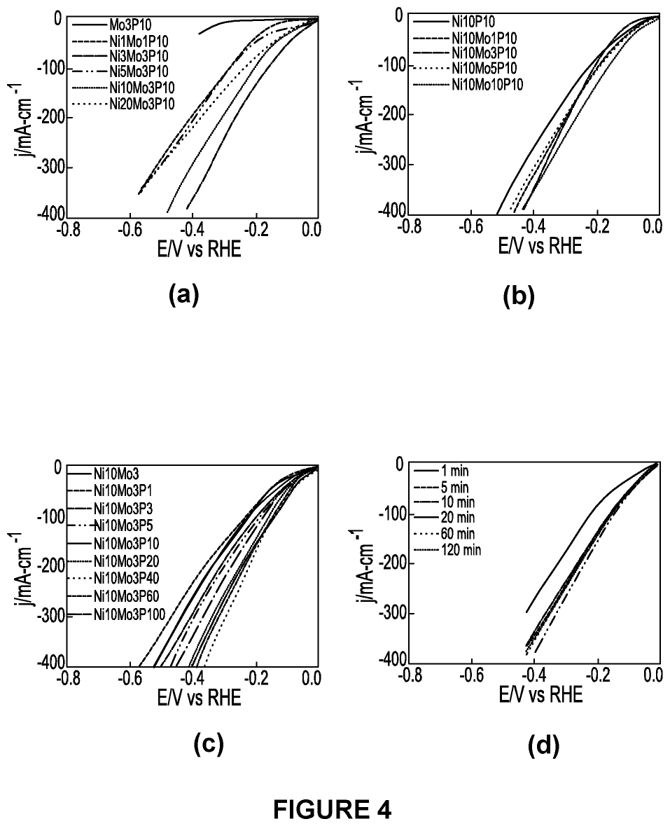

The LSVs for HER performance of the NiMoP composites prepared in Example 1 and control samples were evaluated under basic conditions in 1 M KOH aqueous solution. Composites with different precursor additions and depositing time were investigated as shown in FIG. 4; the optimal additions of Ni:Mo:P were found to be 10:3:40 mmol for 20 min.

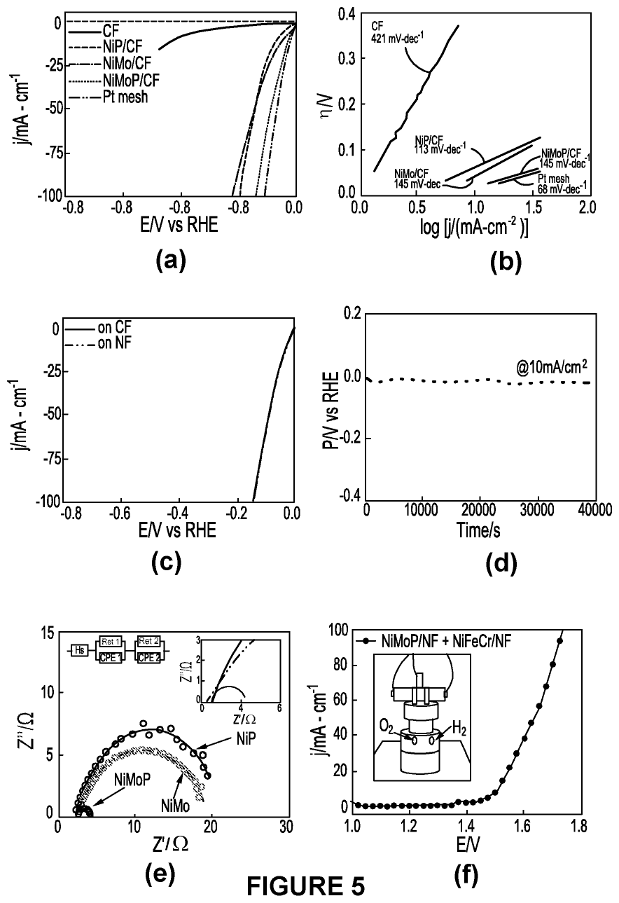

The HER performance of an optimal NiMoP composite is shown in FIG. 5. FIG. 5, panel a illustrates the LSV of the NiMoP electrode compared to NiMo and NiP control electrodes as well as a Pt mesh electrode. The linear sweep voltammetry (LSV) of the NiMoP electrode shows an active onset overpotential (<10 mV) with comparable activity to the Pt mesh electrode. The NiMoP electrode can yield 10 mA·cm⁻² and 100 mA·cm⁻² output at the overpotential of 20 mV and 138 mV respectively. While the NiMo and NiP exhibited activity as HER catalysts, the NiMoP electrode exhibited comparatively enhanced activity. It is noted that a MoP control sample was not able to be prepared via the facile electrodeposition method described above; less composite was obtained on the electrode and showed limited HER performance. FIG. 5, panel b illustrates the Tafel Slopes derived from the LSVs. The NiMoP composite had the lowest value of 78 mV·dec⁻¹ apart from the Pt mesh electrode, indicating a faster charge transfer process during HER process.

The performance of the NiMoP was also evaluated on NF, which showed similar performance as that on CF substrate as shown in FIG. 5, panel c.

The application of the composites over an extended period was also assessed. FIG. 5, panel d illustrates the chronopotentiometry of the NiMoP/CF composite under an applied cathode current density of 10 mA·cm². The results demonstrate the stability and durability of the composite; the feedback potential is maintained at ˜−0.02 V vs RHE (Reversible Hydrogen Electrode) for more than 10 hours without degradation.

The electrochemical impedance spectroscopy (EIS) was also introduced to investigate the kinetics during the HER on the electrode as shown in FIG. 5, panel e. Under the applied potential of −0.10 V vs RHE, a large semicircle is found in Nyquist Plots and another combined semicircle is also observed individually in the insert of FIG. 5, panel e from NiMo, NiP and NiMoP samples. Therefore, it can be simulated with the equivalent circuit (EC) of the Rₛ(R_{ct1}CPF₁)(R_{ct2}CPF₂) model in FIG. 5, panel e, where Rs represents for solution resistance between working electrode and reference and Rai (i=1, 2 . . . ) for the resistance of charge transfer process during reaction (X. Bo et al., Journal of Power Sources 2018, 402, 381-387; I. Herraiz-Cardona et al, International Journal of Hydrogen Energy 2012, 37, 2147-2156). It is noted that due to the porous and rough surface of the CF substrate, the constant phase element (CPE) is introduced to simulate the double layer capacitor value to provide more accurate results. From the simulation of EC, the two charge transfer processes-R_{ct1}CPE₁ and R_{ct2}CPE₂ demonstrate relevant two electrochemical process: the initial reduction of electrode)(M⁺→M⁰) and HER process. The simulated parameters are provided in Table 1. The results show that the NiMoP composite undergoes the smallest R_{ct} values, indicating that less energy input for the intermediate reduction process and accelerated HER process occurred for the NiMoP electrode.

TABLE 1
Simulated parameters from the equivalent circuit of the
Rₛ(R_{ct1}CPF₁)(R_{ct2}CPF₂) model

| | NiMo | NiP | NiMoP |
|---|---|---|---|
| Rₛ/Ω | 2.29 | 2.34 | 2.35 |
| R_{ct1}/Ω | 0.28 | 0.27 | infinitesimal |
| CPE₁/S · sⁿ | 0.0022 | 0.0050 | — |
| n₁/rad | 1 | 0.8953 | — |
| R_{ct2}/Ω | 17.29 | 18.63 | 1.19 |
| CPE₂/S · sⁿ | 0.0121 | 0.0169 | 0.0955 |
| n₂/rad | 0.7048 | 0.8202 | 0.9913 |

FIG. 5, panel f illustrates the LSV in two-electrode system for overall water splitting in 1 M KOH. The onset potential was found to be around ˜1.38 V and could reach to 10 mA·cm⁻² output at ˜1.50 V potential. This indicates that hydrogen evolution in alkaline media was able to be achieved under 1.5 V applied potential. This is shown in the insert photo of FIG. 5, panel f, which illustrates that H₂/O₂ bubbles were generated and released distinctly from the electrodes in the two-electrode system when linked with a AA battery.

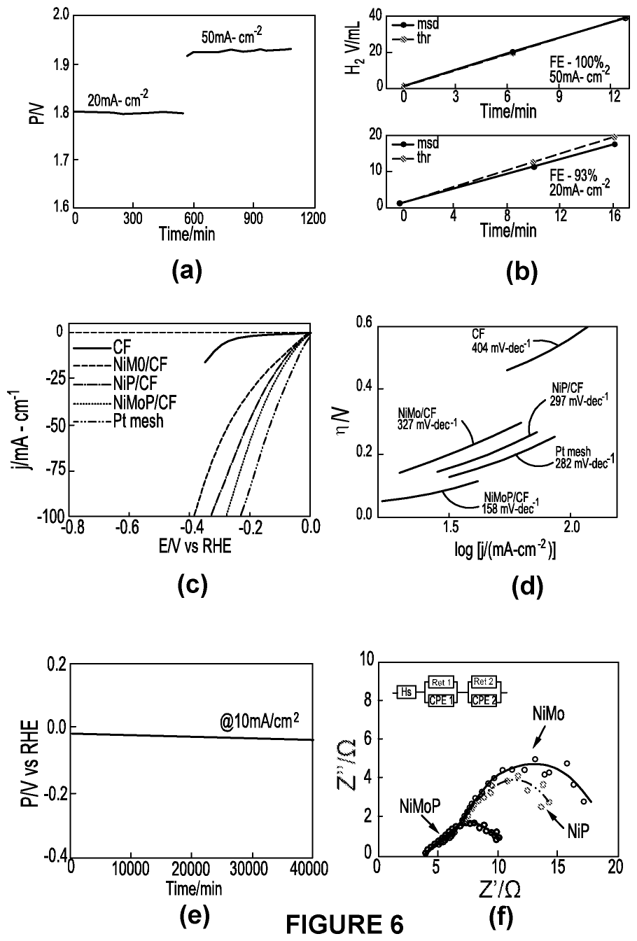

A flow cell system was also designed to further simulate an industrial application. In particular, the anodic NiFeCr/NF and cathodic NiMoP/NF electrodes with the exposed geometric surface area of 3.0×3.0 cm² were attached in an electrolyser and separated with ion-exchange membrane, feeding 30 wt. % KOH aqueous solution by flow pump. FIG. 6, panel a shows the p-t curves under the applied current input of 20 mA·cm⁻² and 50 mA·cm⁻². The feedback potential values were found to stay at a constant ˜1.79 V and ˜1.92 V respectively for more than 20 hours without degradation. The Faraday Efficiency values were measured and are illustrated in FIG. 6, panel b, where the FE values reached >93% under both applied input currents.

The NiMoP composite electrode was also evaluated under neutral conditions in 1 M phosphate buffer solution (PBS, pH=7.2). While the NiP and NiMo control electrodes were shown to have activity in the neutral electrolyte, the involvement of Mo and P into Ni composite significantly accelerated the HER catalytic ability in the neutral environment. FIG. 6, panel c illustrates the LSV for HER performance of the NiMoP composite in PBS. The onset overpotential of NiMoP was found to be ˜13 mV, which was comparatively lower than the value of Pt mesh electrode (·20 mV). To reach the output HER current density of 10 mA·cm⁻¹ and 100 mA·cm⁻¹, feedback potentials of only 30 mV and 230 mV respectively were required. FIG. 6, panel d illustrates the Tafel Slopes derived from the LSVs. The NiMoP composite was found to have the smallest Tafel Slope value, suggesting that the enhanced HER performance of the NiMoP composite may be attributed to the faster charge transfer process. FIG. 6e, panel depicts the long-term stability testing under a current density of 10 mA·cm⁻¹ for more than 10 hours. The feedback potential was found to stabilise at ˜−25 mV vs RHE without degradation. FIG. 6, panel f illustrates EIS plots under the applied potential of −0.10 V vs RHE. Two combined semicircles are presented, indicating the relevant intermediate reduction process and HER in PBS. The EC simulated parameters are listed in Table 2. The NiMoP composite was found to have the smallest R_{ct} values, indicating an accelerated charge transfer process in HER.

TABLE 2
Simulated parameters from the equivalent circuit of the
Rₛ(R_{ct1}CPF₁)(R_{ct2}CPF₂) model

| | NiMo | NiP | NiMoP |
|---|---|---|---|
| Rₛ/Ω | 3.95 | 3.81 | 3.22 |
| R_{ct1}/Ω | 3.16 | 4.32 | 1.26 |
| CPE₁/S · sⁿ | 0.0210 | 0.0300 | 0.0831 |
| n₁/rad | 0.4816 | 0.4584 | 0.5669 |
| R_{ct2}/Ω | 12.51 | 7.87 | 5.53 |
| CPE₂/S · sⁿ | 0.0568 | 0.0668 | 0.2560 |
| n₂/rad | 0.7924 | 0.9147 | 0.6506 |

In addition to having the smallest R_{ct} Values in both alkaline and neutral electrolytes, the significantly improved CPE₂ values of NiMoP representing the double layer capacitor also indicates an enhanced absorption process during HER process, which is beneficial for the formation of the M-H intermediate.

It is to be understood that, if any prior art publication is referred to herein, such reference does not constitute an admission that the publication forms a part of the common general knowledge in the art, in Australia or any other country.

1. A catalyst comprising:
a porous electrically conductive substrate, and
a porous metallic composite coating at least a portion of the surface of the substrate,
wherein the porous metallic composite is amorphous NiMoP.

2. The catalyst of claim 1 wherein composite coats multiple surfaces of the substrate.

3. The catalyst of claim 1, wherein the composite forms a continuous layer which coats the surfaces and pores of the substrate.

4. The catalyst of claim 1, wherein the porous electrically conductive substrate is selected from a foam, carbon fibre paper and carbon fibre cloth.

5. The catalyst of claim 1, wherein the porous electrically conductive substrate is a foam.

6. The catalyst of claim 5 wherein the foam is selected from copper foam, nickel foam, graphite foam, nickel-iron foam, titanium foam and stainless steel foam.

7. The catalyst of claim 6 wherein the foam is copper foam or nickel foam.

8. (canceled)

9. (canceled)

10. (canceled)

11. (canceled)

12. (canceled)

13. (canceled)

14. An electrode comprising the catalyst of claim 1.

15. The electrode of claim 14 wherein the catalyst exhibits catalytic activity towards the hydrogen evolution reaction.

16. (canceled)

17. (canceled)

18. (canceled)

19. The catalyst of claim 1, wherein the thickness of the porous metallic composite is between about 0.01 μm to about 100 μm.

20. The catalyst of claim 1 wherein the ratio of Ni:Mo:P is 10:3:40.
